(19) United States
(12) Patent Application Publication
(10) Pub. No.: US 2005/0024292 A1
(43) Pub. Date: Feb. 3, 2005

(54) Autonomic composite sign and charging system

(75) Inventor: Robert Thomas Cato, Raleigh, NC (US)

Correspondence Address: SAWYER LAW GROUP LLP, PO BOX 51418, PALO ALTO, CA, 94303, US

(73) Assignee: International Business Machines Corporation, Armonk, NY (US)

(21) Appl. No.: 10/630,306

(22) Filed: Jul. 30, 2003

(51) Int. Cl. G09G 5/00

(52) U.S. Cl. 345/1.1

(57) ABSTRACT

A system and method is disclosed for an autonomic composite display. The display includes an n number of display positions in the autonomic composite display where n is at least equal to two; an m number of display devices for engaging the n number of display positions where m is not greater than n; and a composite display controller for presenting an l number of presentations on the m number of display devices wherein the controller automatically detects a change to m and modifies the l number of presentations responsive to the change. The method includes monitoring m number of display devices in the composite display, and adjusting autonomically the presentations on the active displays of the composite display after detecting the change. The adjustments are based upon arrangement parameters that include, for example, order (sequence), priority, and number of duplicate presentations (k) values assigned to each presentation.

### FIELD OF THE INVENTION

The present invention relates generally to composite signs, and more specifically to controlling presentation information on the composite sign when an individual element is removed (such as being taken out of the sign, becoming inactive or failing) or added (such as being inserted into the sign or becoming active).

### BACKGROUND OF THE INVENTION

It is known to provide a composite sign made up of an array of smaller individual displays, such as televisions or monitors. A composite sign may exhibit a single presentation distributed across multiple ones of the individual displays, or it may display multiple individual presentations on each of the displays, or some combination.

A composite sign has a disadvantage in that removal of a display from operation (e.g., taking it out from the sign or deactivating the display) produces a “presentation hole” at the location of the removed display.

Accordingly, what is needed is a method and system for autonomically compensating a composite display for changes in the number of active individual displays. The present invention addresses such a need.

### SUMMARY OF THE INVENTION

A system and method is disclosed for an autonomic composite display. The display includes an n number of display positions in the autonomic composite display where n is at least equal to two; an m number of display devices for engagement with the n number of display positions; and a composite display controller for presenting an l number of presentations on the m number of display devices wherein the controller automatically detects a change to m and modifies the l number of presentations responsive to the change. The method includes monitoring m number of display devices in the composite display, and adjusting autonomically the presentations on the active displays of the composite display after detecting the change.

The present invention autonomically compensates a composite display for changes in the number of active individual displays aggregated into a composite sign based upon a selection process that in the preferred embodiment includes order (sequence), priority, and number of duplicate presentations.

### BRIEF DESCRIPTION OF THE DRAWINGS

FIG. 1 is a schematic block diagram for a preferred embodiment of an autonomic composite sign;

FIG. 2 is a schematic block diagram of the autonomic composite sign having a display removed from the sign shown in the state of FIG. 1;

FIG. 3 is a schematic block diagram of the autonomic composite sign having a display added to the sign shown in the state of FIG. 2;

FIG. 4 is a schematic block diagram of the autonomic composite sign having a display removed from the sign shown in the state of FIG. 2;

FIG. 5 is a schematic block diagram of the autonomic composite sign having a display removed from the sign shown in the state of FIG. 4;

FIG. 6 is a schematic block diagram of the autonomic composite sign having a display removed from the sign shown in the state of FIG. 5;

FIG. 7 is a schematic block diagram of the autonomic composite sign having a display removed from the sign shown in the state of FIG. 6;

FIG. 8 is a schematic block diagram of the autonomic composite sign having a display removed from the sign shown in the state of FIG. 6;

FIG. 9 is a flowchart of a process used by the composite sign in autonomically adjusting the presentations among its individual displays;

FIG. 10 is a generic schematic diagram of a PDA of the type that may be used as device described in FIGS. 1-9;

FIG. 11 is a schematic block diagram of an alternate composite sign system.

FIG. 12 is a schematic block diagram for an alternate preferred embodiment of an autonomic composite sign having presentations arranged based upon order;

FIG. 13 is a schematic block diagram of the autonomic composite sign having a display removed from the sign shown in the state of FIG. 12;

FIG. 14 is a schematic block diagram for an alternate preferred embodiment of an autonomic composite sign having presentations arranged based upon order and priority; and

FIG. 15 is a schematic block diagram of the autonomic composite sign having a display removed from the sign shown in the state of FIG. 14.

### DETAILED DESCRIPTION

The present invention relates to autonomic compensation of presentations on individual displays of a composite sign when the number of active displays making up the composite display is changed. The following description is presented to enable one of ordinary skill in the art to make and use the invention and is provided in the context of a patent application and its requirements. Various modifications to the preferred embodiment and the generic principles and features described herein will be readily apparent to those skilled in the art. Thus, the present invention is not intended to be limited to the embodiment shown but is to be accorded the widest scope consistent with the principles and features described herein.

In the sales environment, systems and applications are being developed to permit a customer to carry a portable POS terminal with them as they walk through an establishment. The POS terminal may provide sales or marketing information to the customer as they move about the establishment. An internal battery that requires periodic recharging typically powers these POS terminals. It is part of the preferred embodiment to adapt the composite sign to include a recharging function for such devices when they are engaged into the sign. Consequently, the devices will have a dual-purpose: to have one use while being carried by the user, and to have another use when installed as part of the composite sign (e.g., presenting static or dynamic marketing and/or sales information for example).

The individual devices are continually removed and added to the composite sign, thus having the composite sign autonomically adapt to these changes enables the composite sign to consistently exhibit information in a useful format. The preferred embodiment will be described in the context of such a representative use, though the present invention is not limited by this specific representative implementation. In some applications, the displays may not be adapted to be taken out of the composite sign, but may otherwise be unavailable (such as when the device becomes inoperable or its function is diverted to another use,). In these cases, the remainder of the active, displays in the composite sign autonomically adapt to continue to present desired information. Similarly, the composite sign adapts to make effective use of individual displays added back (either by being returned or made operable).

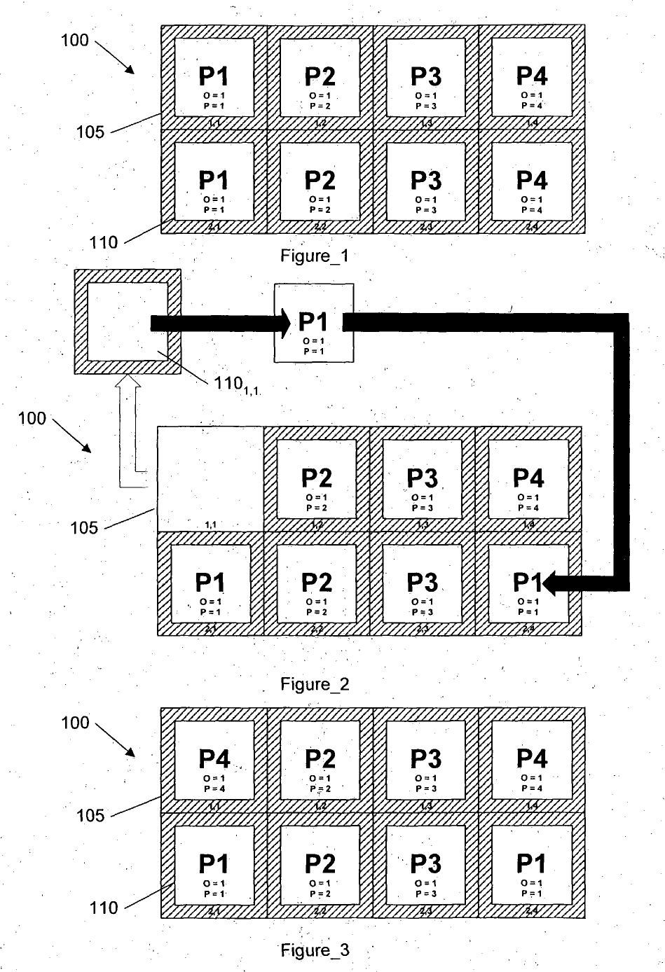

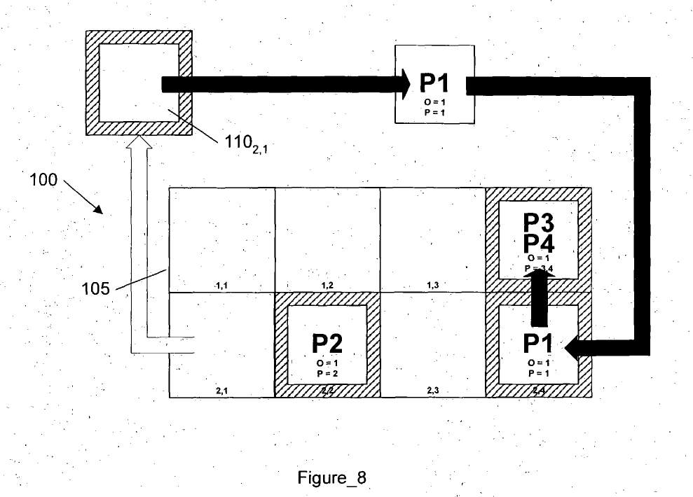

FIGS. 1-8 illustrate one preferred set of adjustment rules to control exhibition of a set of presentations on a set of devices that define the autonomic sign. This set of rules places presentations in active devices of the autonomic sign, considering a priority and duplicate presentations (k) parameters. Note that all presentations of FIGS. 1-8 have the same order attribute (o), but different priority attributes (p). The number of duplicate individual presentations (k) will help determine how presentations are replaced and/or moved. An order parameter is effectively ignored in this case since they have the same parameter value, with this rule set being representative and other rule sets possible or desirable depending upon the specific implementation:
1) If the number of presentations is less than or equal the number of display devices, then the presentations will be sequentially assigned random locations, with the highest priority presentations being assigned a random location first, the second priority presentation being assigned a random location second, and so forth. After lowest priority presentation is randomly assigned a location, the location process starts again with the highest priority presentation. This process repeats until all of the available locations have a presentation assigned.
2) If there are more presentations than there are display devices, then the presentations will be assigned random locations, with the highest priority presentations being assigned a random location first, the second priority presentation being assigned a random location second, and so forth. This is illustrated in FIGS. 2, 4, 5, 6, and 7.
3) Two alternatives are illustrated for the treatment of presentations for which there is no location available. One alternative is to eliminate the lower priority presentations from the composite display. This is illustrated on FIG. 7. Another alternative is to merge the lower priority presentations into a single presentation and to display this merged single presentation at the composite structure position that is last on the order list. (In figures, the last position is 2,4.) The merged P3/P4 presentation is illustrated on FIG. 8.

FIG. 1 is a schematic block diagram for a preferred embodiment of an autonomic composite sign 100. Composite sign 100 includes a structure 105 having a plurality of display locations, each location adapted to receive an individual electronic display device 110 and in some applications to recharge device 110 when engaged. Each device 110 exhibits a presentation Px as part of the aggregate display of sign 100, where x designates a specific presentation.

To simplify the explanation, sign 100 is shown as an ordered 2×4 matrix of devices 110, though other configurations are possible within the scope of the present invention, including arrays and irregular patterns of dissimilar sized devices 110. It is known to arrange a plurality of televisions or monitors into regular patterns to produce a composite sign, devices 110 may include other electronic devices such as personal digital assistants (PDAs), tablet PCs, portable point-of-sale (POS) terminals, or other devices having a display with content that is electronically controlled.

Presentation Px is the currently exhibited presentation on the associated device 110. Depending upon the application and the type of device 110, each presentation Px may be a motion, static or “slideshow” image or image sequence, for example. Depending upon many factors, the various presentations Px have a certain arrangement (e.g., priority and/or order) relative to the other presentations Px at any given time. These priorities may be static or dynamic, and may depend upon many factors. The preferred embodiment does not have any preference on the number of display locations in a composite sign, the number of displays or number and/or type of presentations. For FIG. 1 through FIG. 8, each presentation Px has been assigned the same order parameter (e.g., order=1) with different presentations having differing priorities, though different arrangement parameters may be used individually or collectively depending upon a desired implementation.

It is a goal of the preferred embodiment for composite sign 100 to adapt to changes in the number of active devices 110 available in structure 105, either changes due to the removal or addition of one or more devices 110. Sign 100 exhibits presentations Px consistent with its selection and arrangement process based upon the individual presentations' arrangement parameters and the number and placement of devices 110 available in structure 105.

FIG. 2 is a schematic block diagram of autonomic composite sign 100 having device 110_{1,1} removed from sign 100 shown in the state of FIG. 1. Device 110_{1,1} was exhibiting presentation P1 at the time it was removed, with presentation P1 assigned the greatest priority. Removing device 110_{1,1} results in sign 100 having a single incidence of the presentation P1, therefore sign 100 may adjust the remainder of active devices 110 by replacing presentation P4 on device 110_{2,4} with presentation P1.

FIG. 3 is a schematic block diagram of autonomic composite sign 100 having device 110_{1,1} added to sign 100 shown in the state of FIG. 2. Before device 110_{1,1} was added, sign 100 had a single incidence of the presentation P4, therefore sign 100 may adjust the remainder of active devices 110 by exhibiting presentation P4 on device 110_{1,1} when it is detected.

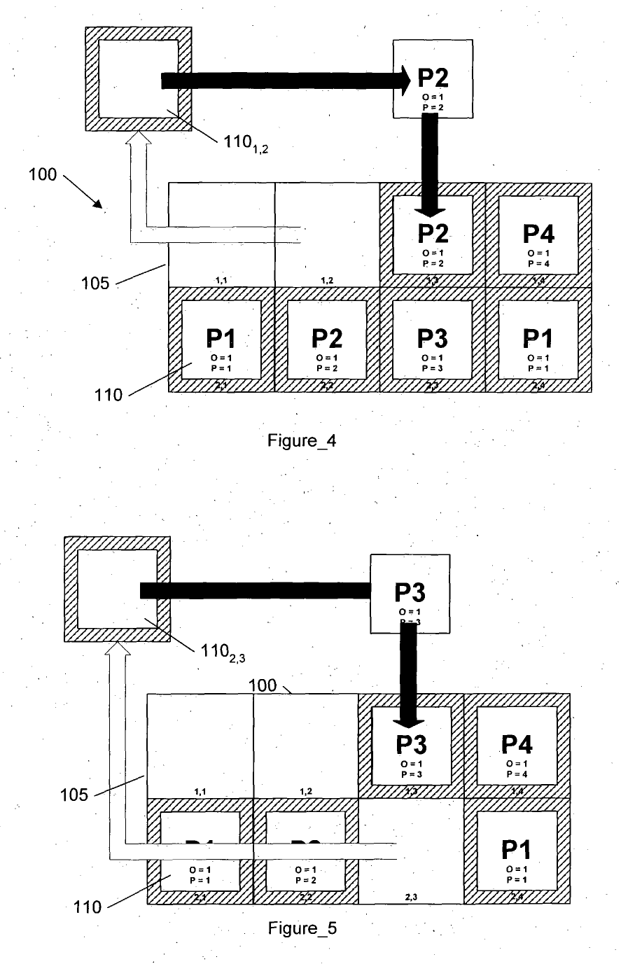

FIG. 4 is a schematic block diagram of autonomic composite sign 100 having device 110_{1,2} removed from sign 100 shown in the state of FIG. 2. Device 110_{1,2} was exhibiting presentation P2 at the time it was removed, with presentation P2 assigned the second greatest priority. Removing device 110_{1,2} results in sign 100 having a single incidence of the presentations P2 and P4, therefore sign 100 may adjust the remainder of active devices 110 by replacing presentation P3 on device 110_{1,3} with presentation P2.

FIG. 5 is a schematic block diagram of autonomic composite sign 100 having device 110_{2,3} removed from sign 100 shown in the state of FIG. 4. Device 110_{2,3} was exhibiting presentation P3 at the time it was removed, with presentation P3 assigned the third greatest priority. Removing device 110_{2,3} results in sign 100 having a no incidences of the presentation P3 and a single incidence of presentation P4, therefore sign 100 may adjust the remainder of active devices 110 by replacing presentation P2 on device 110_{1,3} with presentation P3.

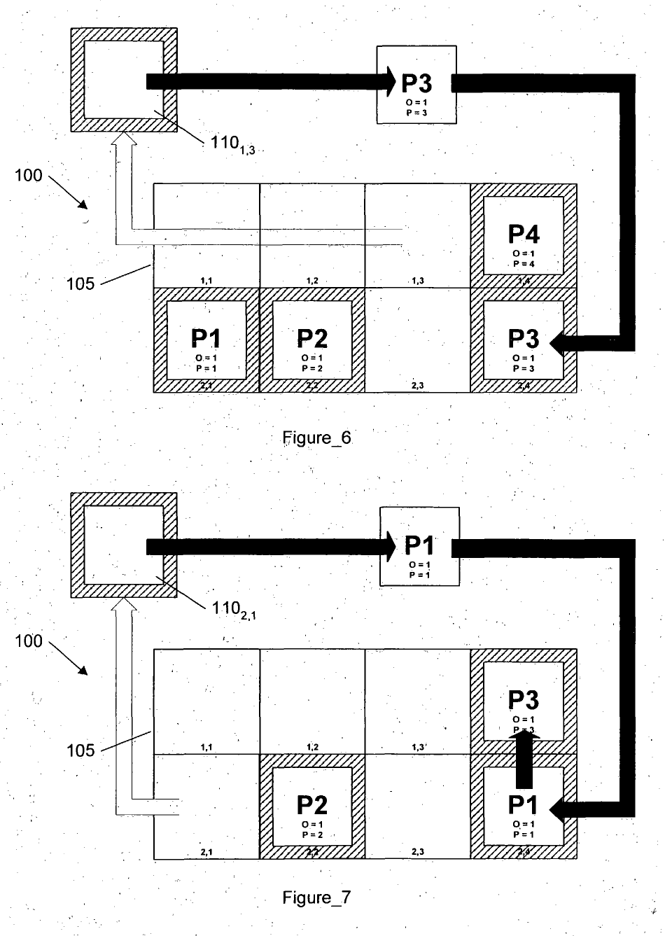

FIG. 6 is a schematic block diagram of autonomic composite sign 100 having device 110_{1,3} removed from sign 100 shown in the state of FIG. 5. Device 110_{1,3} was exhibiting presentation P3 at the time it was removed, with presentation P3 assigned the third greatest priority. Removing device 110_{1,3} results in sign 100 having a no incidences of the presentation P3, a single incidence of presentations P2 and P4 and two incidences of presentation P1, therefore sign 100 may adjust the remainder of active devices 110 by replacing presentation P1 on device 110_{2,4} with presentation P3.

FIG. 7 is a schematic block diagram of autonomic composite sign 100 having device 110_{2,1} removed from sign 100 shown in the state of FIG. 6. Device 110_{2,1} was exhibiting presentation P1 at the time it was removed, with presentation P1 assigned the greatest priority. Removing device 110_{2,1} results in sign 100 having a no incidences of the presentation P1 and a single incidence of presentations P2, P3 and P4, therefore sign 100 may adjust the remainder of active devices 110 by replacing presentation P3 on device 110_{2,4} with presentation P1. Additionally, sign 110 may further adjust other devices 110, such as by replacing presentation P4 on device 110_{1,4} with presentation P3 since presentation P4 has the lowest priority and replacing presentation P3 on device 110_{2,4} with presentation P1 resulted in no incidence of presentation P3 on sign 100. FIG. 7 illustrates that sign 100 may adapt one or more active devices 110 in response to detected changes of the number of devices, 110 of sign 100.

FIG. 8 is a schematic block diagram of autonomic composite sign 100 having device 110_{2,1} removed from sign 100 shown in the state of FIG. 6. FIG. 8 is an alternative to the result shown in FIG. 7 in that sign 100 may create or exhibit a composite of presentations when the number of devices 110 is less than the number of presentations. Device 110_{2,1} was exhibiting presentation P1 at the time it was removed, with presentation P1 assigned the greatest priority. Removing device 110_{2,1} results in sign 100 having a no incidences of the presentation P1 and a single incidence of presentations P2, P3 and P4, therefore sign 100 may adjust the remainder of active devices 110 by replacing presentation P3 on device 110_{2,4} with presentation P1. Additionally, sign 110 may further adjust other devices 110, such as by changing presentation P4 on device 110_{1,4} with a composite presentation P3/P4 since replacing presentation P4 with presentation P3 would result in no incidence of presentation P4. FIG. 8 illustrates that sign 100 may adapt one or more active devices 110 in response to detected changes of the number of devices 110 of sign 100 and that it may exhibit composite or modified presentations among the available displays.

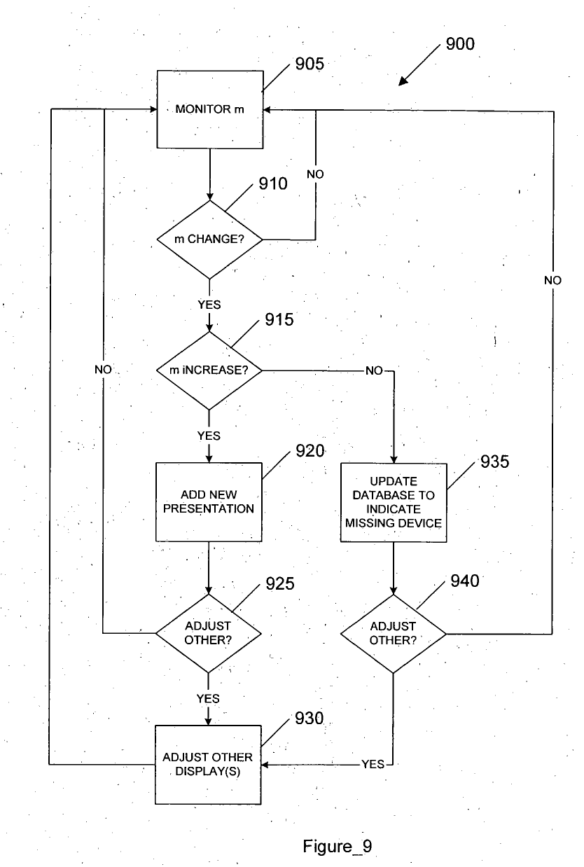

FIG. 9 is a flowchart of a process 900 used by sign 100 in autonomically adjusting the presentations among its individual displays. For purposes of the discussion of process 900, the integers n, m, l and k represent various quantities. The number n is the number of device locations available in structure 105, m is the number of active devices 110 present in structure 105, l is the number of distinct presentations available for presentation on sign 100 and k is the number of instances of any particular presentation.

Process 900 monitors the m number of devices 110 engaged into structure 105 at step 905. Sign 100 may detect the removal or addition of device 110 from structure 105 by many different methods. For example, a physical interlock or switch, a scanner associated, or a power/data detector associated with each location are among the types of detecting systems used by the preferred embodiment. After step 905, process 900 makes a check to determine whether m has changed at step 910. If no change in m is detected, process 900 returns to step 905 and continues to cycle through step 905 and step 910 until the test at step 910 determines that m has changed in response to an addition or removal of a display device 110.

When m changes, process 900 advances to step 915 to determine whether m has increased (device 110 added). When m increases, process 900 advances to step 920 from step 915 to add a presentation Px onto the newly added display device 110. Step 920 may use many different decision conditions to determine which particular presentation Px to add to the newly added display device 110. The preferred embodiment uses the current values of k to determine which presentation(s) to add, generally adding presentation Px having k=0 before presenting multiple copies of other presentation(s) Px. However, it may be desirable to have multiple instances of higher priority items before certain lower priority items are presented. Sign 100 could require that k for presentation P1 exceed a threshold before adding any instances of presentation P4 for example.

After selecting a presentation Px for the newly added device 110, process 900 advances to step 925 to determine whether presentation(s) on other device(s) 110 other than the newly added device should be changed as well. The decision tree for the test at step 925 will vary depending upon specific applications, but in some cases the addition of device 110 may warrant further changes to other devices. For example, sign 100 may desire to decomposite certain presentations Px or it may reorder one or more presentations. The preferred embodiment may make some of the adjustments based upon location of devices 110 within structure 105. For example, a device in location 1,1 (when available) may always have a particular presentation Px, and other devices have their presentation adjusted accordingly. Sign 100 may select presentations Px based upon physical location and orientation of one or more devices. For example, a presentation Px may be available for exhibition only on contiguous devices 110, such as two side-by-side, or top-to-bottom, or for four devices active in a 2×2 matrix on structure 105.

When the test at step 925 is negative, process 900 returns to step 905 to monitor for additional changes to m. When the test at step 925 is positive, process 900 advances to step 930 from step 925 to adjust other devices as necessary. After step 930, process 900 returns to step 905 to monitor m.

Process continues to process steps 905-930 as discussed above for increases to m. However, when the test at step 915 is negative (meaning m has decreased), process 900 advances to step 935 from step 915. Step 935 is to update the database to indicate the missing device 110.

Step 940 then decides whether to adjust the other presentations Px. The decision tree to decide which presentation Px is to be replaced, if any, from the currently active devices 110 uses many factors including the particular implementation, the presentation Px that had been available on the removed device 110 and the arrangement parameters used in sign 100 (e.g., presentation priority and presentation order).

The preferred embodiment uses k as well as well as the priority of the presentation Px for the removed device 110 to decide what presentation Px should be removed from sign 100. Step 940 makes a similar test as described above regarding test 925. Process 900 determines whether to adjust any other presentation(s) Px on the remaining active devices 110. It may be that sign 100 is symmetrical in its adjustment of presentations when devices 110 are added as it is with when devices 110 are removed, but it is not necessary that it be implemented in this way.

When test 940 determines that no adjustment is necessary, process 900 returns to step 905 to monitor for changes to m. When test 940 determines that other adjustment(s) to presentation(s) Px of other device(s) 110 is necessary, process 900 advances to step 930 from step 940. Process 900 continues to autonomically adapt the presentations Px of the active devices 110 based upon process 900 in response to the additions and removals of devices 110 from sign 100.

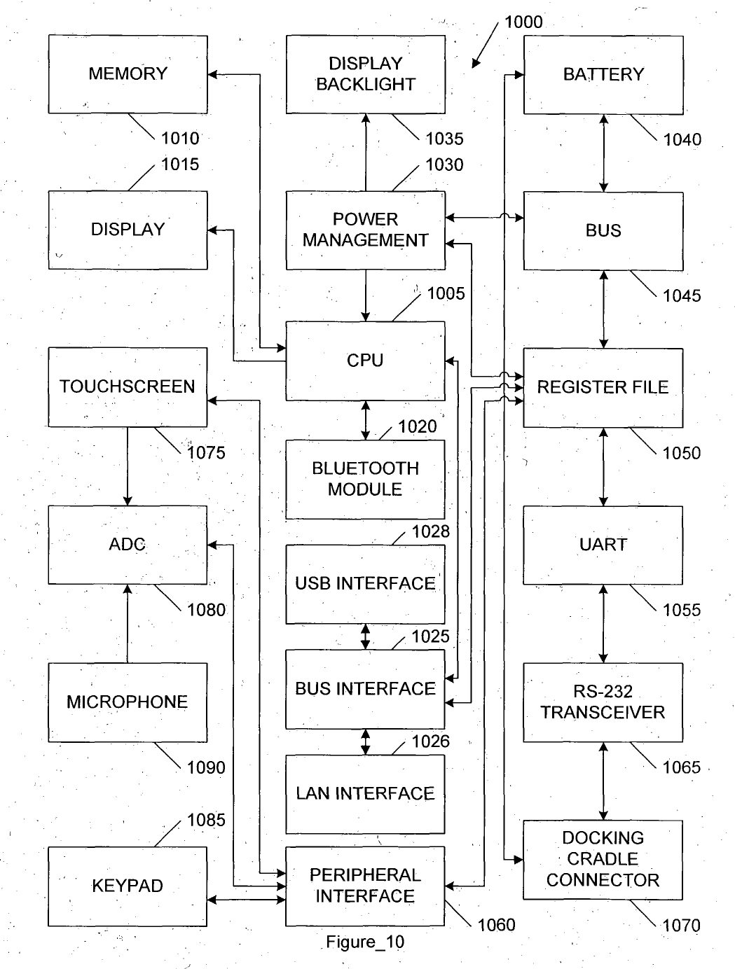

FIG. 10 is a generic schematic diagram of a PDA, webpad, or other display-bearing electronic device 1000 of the type that may be used as device 110 described in FIGS. 1-9. PDA 1000 includes a central processing unit 1005 that interfaces to memory 1010, a display 1015, a Bluetooth module 1020, a bus interface 1025, a LAN (wired or wireless) interface 1026, a USB interface 1028, and a power management module 1030. CPU 1005 controls the operation of device 1000 under instructions stored in memory 1010 to exhibit the appropriate presentation Px on display 1015 at the appropriate time. CPU 1005 may receive presentation Px information from memory, from Bluetooth module 1020, or from another peripheral device through bus interface 1025.

CPU 1005 monitors power status from power management module 1030, with power management module, 1030 controlling the state of a display backlight 1035 and monitoring a status of a battery 1040 through a bus (e.g., SMBus) 1045. CPU 1005 controls operation of power management 1030 and sends/receives data and/or control signals to other peripherals by use of a register file 1050 coupled to bus interface 1025. Register file 1050, through which CPU 1005 controls/communicates with certain of the components, is additionally coupled to power management 1030, bus 1045, a universal asynchronous receiver-transmitter (UART) 1055, and a peripheral interface 1060 for interfacing information to CPU 1005.

UART 1055 is coupled to a RS-232 transceiver 1065 that is coupled in turn to a docking cradle connector 1070. Docking cradle 1070 is also coupled to battery 1040 when recharging is desired. Peripheral interface 1060 may be a serial peripheral interface or an inter-integrated circuit (12C) for example to interface to a touchscreen 1075, an analog-digital converter (ADC) 1080, or a keypad 1085. In some applications, a microphone 1090 coupled to ADC 1080 may be used as well.

The components of PDA 1000 are but one example of a suitable configuration, with CPU 1005 controlling operation and receiving information based upon instructions in memory 1010. Memory 1010 may be removable, and is preferably non-volatile. Other configurations of the components, or additional components may be used to configure a suitable device 110.

In one preferred embodiment, process 900 is implemented by CPU 1005 of each of the active devices 110 in sign 100, with devices 110 establishing a local area network and deciding among themselves which presentations Px are exhibited by the individual devices at any given time. The presentations Px may be stored locally in memory 1010, or accessed through a peripheral device (e.g., Bluetooth module 1020, LAN interface 1026 or USB interface 1028) or devices 110 may include reference pointers to external data with the particular presentation. In some instances, a particular device 110 may be a master device determining presentations Px for itself and the other devices, with a mechanism established for ceding master status to another device should the master be removed.

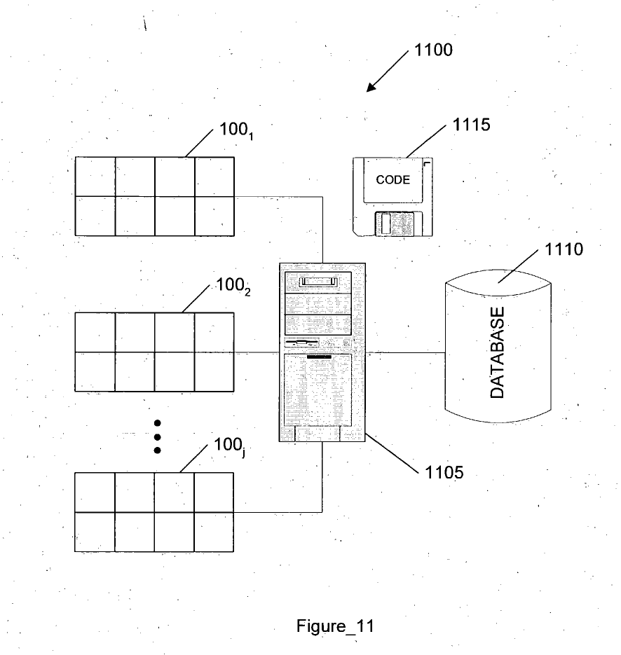

FIG. 11 is a schematic block diagram of an alternate composite sign system 1100. System 1100 includes a server 1105 coupled to a presentation database 1110 and operated according to instructions on a nonvolatile removable memory 1115 implementing process 900 to control one or more composite signs 100ₓ. Server 1105 instructs each device 110 of each sign 100ₓ as to which presentation to exhibit as discussed above using process 900.

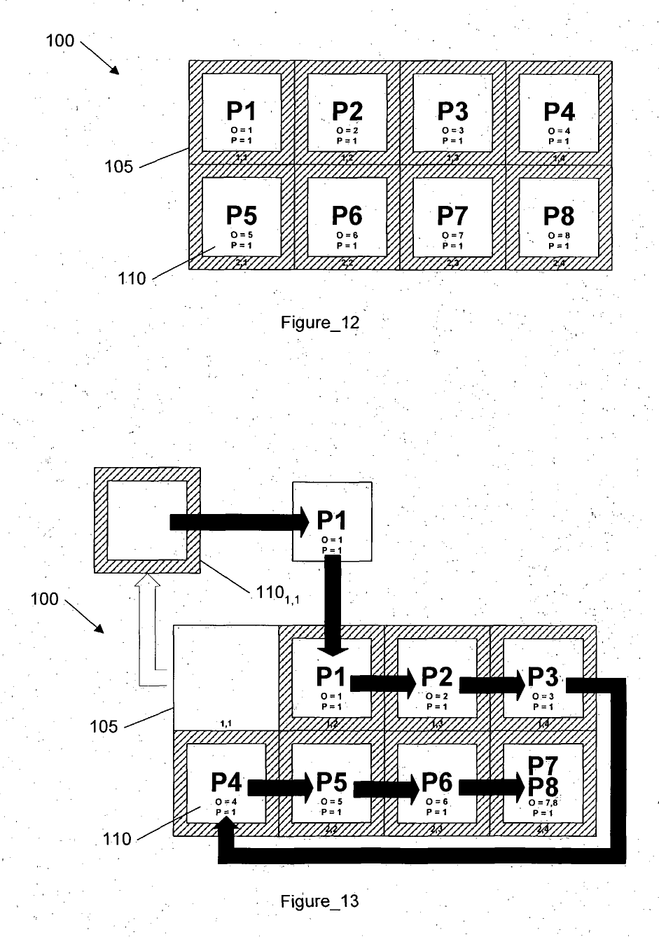

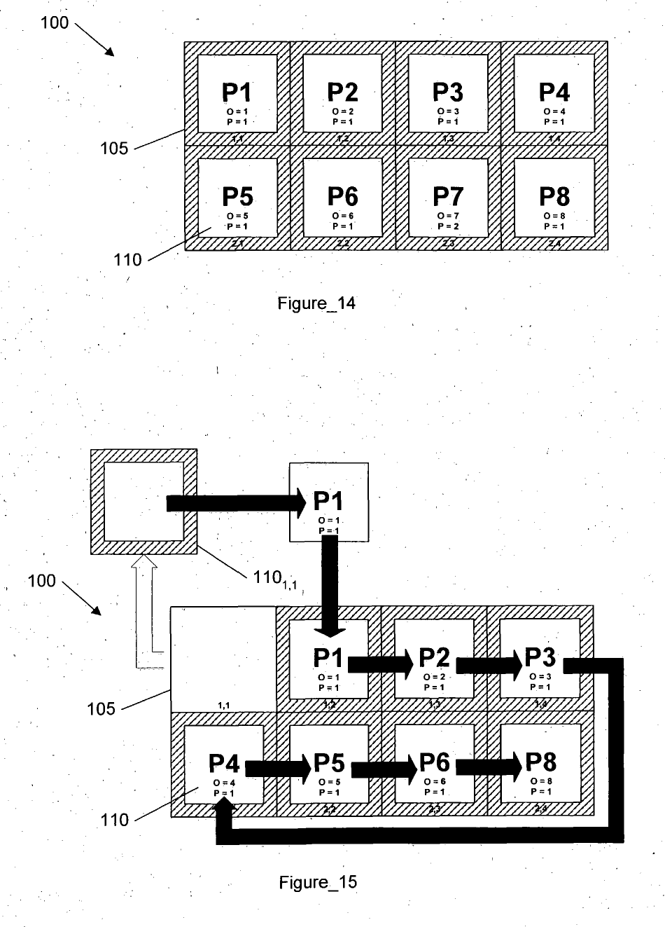

Presentation arrangement of FIGS. 12-15 uses the following rules to place presentations and consider both the order and priority parameters. Again, specific implementations may use a different set of rules.
1) The presentation with the lowest order parameter is placed on the display device located in the composite display structure position with the lowest order parameter. Thus a presentation with an order parameter of 1 will be placed in the upper left corner position of the structure, position (1,1).
2) If two presentations have the same order number, then the presentation with the highest priority is placed on the display device located in the composite display structure position with the lowest order parameter. (In the example, a priority value of 1 is a higher priority that a value of 2.)
3) If two presentations have the same order number and the same priority, then they are located randomly.
4) If there are more presentations than there are display devices and all of the presentations have the same priority, then two or more presentations will be merged into a single presentation and placed on one of the display devices. The merged presentations will first be displayed at the composite structure position that is last on the order list. FIGS. 12 and 13 illustrate this, with the P7 and P8 presentations merged and place in position 2,4.
5) If there are more presentations than there are display devices, then the presentations with the lower priority will be eliminated from the composite display and replaced with presentations with higher priority. FIGS. 14 and 15 illustrate this, with P7 being eliminated.
6) If there are less presentations than there are display devices, then two or more of the same presentations will be placed on two or more of the display devices. If all of the presentations have the same priority, the duplicate presentations will be those with the last order values. Thus the duplicate presentations would be initially displayed at the composite structure position that is last on the order list. In FIGS. 12 and 13 these are positions 2,3 and 2,4.
7) If there are loss presentations than there are display devices, then two or more of the same presentations will be placed on two or more of the display devices. If the presentations have different priorities, the duplicate presentations will be those with the lowest priority. The reason for this is to simplify the process by giving images such as logos a low priority and thus allowing multiple presentations of logos. Thus the duplicate presentations would be initially displayed at the composite structure position that is last on the order list. In FIGS. 12 and 13 these are positions 2,3 and 2,4.

FIG. 12 is a schematic block diagram for an alternate preferred embodiment of an autonomic composite sign 100 having presentations Px arranged based upon order. Eight presentations Px, x=1-8, are exhibited on eight devices 110 engaged with structure 105. These presentations Px each have a priority=1, but a different presentation order parameter value O=1-8, respectively.

FIG. 13 is a schematic block diagram of autonomic composite sign 100 having display 110_{1,1} removed from sign 100 shown in the state of FIG. 12. Device 110_{1,1} was exhibiting presentation P1 at the time it was removed, with presentation P1 assigned the first order value. Removing device 110_{1,1} results in sign 100 lacking presentation Px having O=1, therefore sign 100 adjusts the presentations on the remainder of active devices 110 by cascading presentation replacements. Presentation P1 is exhibited on device 1101,2 where presentation P2 having order O=2 was previously exhibited. Since presentation P2 had an order O=2, higher than others of the presentations Px exhibited by sign 100, presentation P2 replaces an existing presentation Px having a lower order. The process of replacement continues with any replaced presentation re-exhibited in place of a lower ordered presentation Px until there are no more active devices 110. In FIG. 13, sign 100 creates a composite presentation P7/P8, though other implementations may result in replacing presentation P8 with presentation P7.

In the discussion above, the order parameter establishes an absolute presentation order between available devices 110 in the specific location in structure 105. In some embodiments, the order parameter may establish a relative order between presentations Px where location within structure 105 does not need to be preserved. In an implementation of such an embodiment, removal of a device 110 having a presentation Px with a specific order parameter value would replace presentation Px having the lowest order parameter value (provided that the priority was the same) and the presentation Px having the second lowest order parameter value would be modified according to the decision logic and parameter values of the two lowest ordered presentations Px.

FIG. 14 is a schematic block diagram for an alternate preferred embodiment of an autonomic composite sign 100 having presentations Px arranged based upon both order and priority. Eight presentations Px, x=1-8, are exhibited on eight devices 110 engaged with structure 105. Seven of these presentations Px (1-6, and 8) each have a priority=1 and presentation P7 has a presentation priority=2, but a different presentation order parameter value O=1-8 for each presentation Px, respectively.

FIG. 15 is a schematic block diagram of the autonomic composite sign having a display removed from the sign shown in the state of FIG. 14. Device 110_{1,1} was exhibiting presentation P1 at the time it was removed, with presentation P1 assigned the first order value. Removing device 110_{1,1} results in sign 100 lacking presentation Px having O=1, therefore sign 100 adjusts the presentations on the remainder of active devices 110 by cascading presentation replacements. Presentation P1 is exhibited on device 1101,2 where presentation P2 having order O=2 was previously exhibited. Since presentation P2 had an order O=2, higher than others of the presentations Px exhibited by sign 100, presentation P2 replaces an existing presentation Px having a lower order but with the same priority. The process of replacement continues with any replaced presentation re-exhibited in place of a lower ordered, same priority presentation Px. In FIG. 15, sign 100 drops presentation P7 because it has lower priority than presentation P6 and presentation P8. Presentation P6 replaces presentation P7 because it is higher-ordered. Presentation P7 is unable to replace presentation P8 because presentation P8 has a higher priority.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

1. An autonomic composite display, comprising:
an n number of display positions in the autonomic composite display where n is at least equal to two;
an m number of display devices for engaging the n number of display positions; and
a composite display controller for presenting an l number of presentations on the m number of display devices wherein the controller automatically detects a change to m and, modifies the l number of presentations responsive to the change.

2. The autonomic composite display of claim 1 wherein the l number of presentations are selected from a set of individual presentations and wherein the controller presents a k number of instances of one or more individual presentations.

3. The autonomic composite display of claim 2 wherein the controller reduces k for a particular presentation Px by 1 when m is reduced by 1.

4. The autonomic composite display of claim 2 wherein the controller increases k for a particular presentation Px by 1 when m is increased by 1.

5. The autonomic composite display of claim 1 wherein the l number of presentations are selected from a set of individual presentations, wherein the controller presents a k number of instances of one or more individual presentations on the m number of display devices and wherein m is reduced by 1 by removing an mth display device from the autonomic composite display, the controller substituting a composite presentation on a selected one of the m−1 display devices when detecting the change to m, with the composite presentation including elements from a presentation previously presented on the mth display device and from a presentation previously presented on the selected display device at the time that the change was detected.

6. The autonomic composite display of claim 2 wherein the individual presentations each have an associated priority and wherein m is reduced by 1 by removing a display device having a particular presentation from the autonomic composite display, the controller substituting the particular presentation for a displayed presentation on one of the remaining m−1 display devices when the displayed presentation has a lower priority than the particular presentation.

7. The autonomic composite display of claim 6 wherein the controller first substitutes displayed presentations having k greater than 1.

8. The autonomic composite display of claim 2 wherein the individual presentations each have an associated priority and wherein m is reduced by 1 by removing a display device having a particular presentation from the autonomic composite display, the controller substituting the particular presentation for a displayed presentation on one of the remaining m−1 display devices when the displayed presentation has a priority equal to the particular presentation and the displayed presentation has k greater than 1.

9. A method of autonomically adjusting presentations on each of a plurality of electronic display devices making up a composite sign in response to a change in the number of display devices used in the sign under control of a computing system, comprising the steps of:
a) monitoring for a change in m by the computing system, where m was the number of active devices in the composite sign before the change and m′ is the number of active devices in the composite sign after the change; and
b) adjusting, by the computing system, one or more presentations exhibited on the m′ devices in response to the change.

10. The method of claim 9 wherein the adjusting step b) uses arrangement parameter values assigned to each presentation.

11. The method of claim 10 wherein the arrangement parameter values include priority values.

12. The method of claim 10 wherein the arrangement parameter values include order values.

13. The method of claim 10 wherein the arrangement parameter values include duplicate presentation number values.

14. An autonomic composite display, comprising:
means for arranging a first plurality of devices into the composite display, with the devices exhibiting a second plurality of presentations;
means for discretely and independently exhibiting the second plurality of presentations; and
means for controlling a third plurality of presentations on the exhibiting means including automatic detection of a change to the second plurality and modification to the third plurality responsive to the change.

15. A computer usable medium having computer readable program code means embodied therein for autonomically adjusting exhibited presentations on a composite sign, the computer readable program code means in the computer usable medium comprising:
computer readable program code means for arranging a first plurality of presentations into a plurality of devices of the composite display;
computer readable program code means for discretely and independently exhibiting a second plurality of presentations; and
computer readable program code means for controlling the second plurality of presentations on the exhibiting means including automatic detection of a change to the first plurality and modifies the second plurality responsive to the change.
